(19) United States
(12) Patent Application Publication
(10) Pub. No.: US 2026/0268090 A1
(43) Pub. Date: Sep. 10, 2026

(54) MODEL INFERENCE METHOD AND ELECTRONIC DEVICE

(71) Applicant: Lenovo (Beijing) Limited, Beijing (CN)

(72) Inventors: Ziqi CHEN, Beijing (CN); Jianchao LIU, Beijing (CN)

(21) Appl. No.: 19/553,399

(22) Filed: Mar. 1, 2026

(30) Foreign Application Priority Data
Mar. 5, 2025 (CN) 202510258832.1

(51) Int. Cl. G06F 40/35; G06F 40/40

(52) U.S. Cl. CPC G06F 40/35; G06F 40/40

(57) ABSTRACT

A model inference method includes obtaining input prompt information of a current dialogue, and generating first token output information and predicted token output information corresponding to the input prompt information based on model inference. The predicted token output information is generated based on reference token pairs related to attributes of the current dialogue.

### CROSS-REFERENCE TO RELATED APPLICATION

This application claims priority to Chinese Patent Application No. 202510258832.1, filed on Mar. 5, 2025, the entire content of which is incorporated herein by reference.

### TECHNICAL FIELD

The present disclosure generally relates to the field of model inference technology and, more particularly, to a model inference method and electronic device.

### BACKGROUND

In related art, large language models perform inference in a token-by-token autoregressive manner, generating each subsequent token based on previously generated tokens until completion. This generation paradigm results in relatively slow output speeds, particularly on edge devices with limited computational resources, thereby significantly degrading user experience.

Therefore, improving the inference speed of large language models has become an urgent problem to be solved.

### SUMMARY

In accordance with the disclosure, there is provided a model inference method including obtaining input prompt information of a current dialogue, and generating first token output information and predicted token output information corresponding to the input prompt information based on model inference. The predicted token output information is generated based on reference token pairs related to attributes of the current dialogue.

Also in accordance with the disclosure, there is provided there is provided an electronic device including a processor, and a memory storing an application program that, when executed by the processor, causes the electronic device to obtain input prompt information of a current dialogue, and generate first token output information and predicted token output information corresponding to the input prompt information based on model inference. The predicted token output information is generated based on reference token pairs related to attributes of the current dialogue.

Also in accordance with the disclosure, there is provided there is provided a non-transitory computer-readable storage medium storing an application program that, when executed by a processor, causes an electronic device including the processor to obtain input prompt information of a current dialogue, and generate first token output information and predicted token output information corresponding to the input prompt information based on model inference. The predicted token output information is generated based on reference token pairs related to attributes of the current dialogue.

### BRIEF DESCRIPTION OF THE DRAWINGS

To more clearly illustrate the technical solutions in the present disclosure, the drawings used in the description of the present disclosure will be briefly introduced below. Obviously, the drawings described below are only some embodiments recorded in the present disclosure. For those skilled in the art, other drawings can be obtained based on these drawings without creative effort.

FIG. 1 is a flowchart of a model inference method consistent with the present disclosure.

FIG. 2 shows a flowchart of updating a reference token pair information library in a model inference method consistent with the present disclosure.

FIG. 3 shows a flowchart of updating a reference token pair information library based on target token pairs in a model inference method consistent with the present disclosure.

FIG. 4 is a schematic structural diagram of an electronic device consistent with the present disclosure.

FIG. 5 is a schematic structural diagram of another electronic device consistent with the present disclosure.

### DETAILED DESCRIPTION OF THE EMBODIMENTS

Various embodiments and features of the present disclosure are described herein with reference to the accompanying drawings.

It should be understood that various modifications can be made to the embodiments of the present disclosure. Therefore, the above description should not be considered as limiting, but merely as examples of embodiments. Other modifications within the scope and spirit of the present disclosure will be apparent to those skilled in the art.

The accompanying drawings, which are included in and constitute a part of this specification, illustrate embodiments of the present disclosure and, together with the general description of the present disclosure given above and the detailed description of the embodiments given below, serve to explain the principles of the present disclosure.

The features of the present disclosure will become apparent from the following description of embodiments given as non-limiting examples with reference to the accompanying drawings.

It should also be understood that although the present disclosure has been described with reference to specific examples, those skilled in the art can implement many other equivalent forms of the present disclosure, which have the features described in the claims and are therefore all within the scope of the present disclosure.

The above and other aspects, features, and advantages of the present disclosure will become more apparent when taken in conjunction with the accompanying drawings, in light of the following detailed description.

Specific embodiments of the present disclosure are described thereafter with reference to the accompanying drawings. However, it should be understood that the claimed embodiments are merely examples of the present disclosure, which may be implemented in various ways. Well-known and/or repeated functions and structures are not described in detail to avoid unnecessary or redundant details that would obscure the present disclosure. Therefore, the specific structural and functional details claimed herein are not intended to be limiting, but merely to serve as a basis and representative basis for teaching those skilled in the art to use the present disclosure in a variety of suitable detailed structures.

This specification may use the phrases “in one embodiment,” “in another embodiment,” “in yet another embodiment,” or “in other embodiments,” all of which may refer to one or more of the same or different embodiments according to the present disclosure.

To facilitate understanding of the present disclosure, a model inference method consistent with the present disclosure is described below.

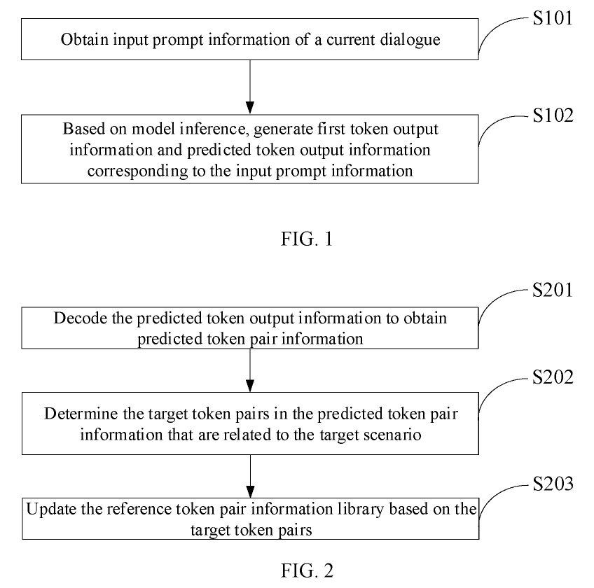

FIG. 1 is a flowchart of the model inference method consistent with the present disclosure, which includes S101 and S102.

At S101, input prompt information of a current dialogue is obtained.

In some embodiments, the model is a large language model, and both the input and output information of this model are in text form. For example, a smart consultation terminal is equipped with a large language model, which can receive the patient’s input information, initiate a dialogue mode with the patient, and use the large language model to reason through the input information to obtain corresponding output information, which is then displayed to the patient, thus completing the dialogue. The dialogue with the patient can have multiple rounds, meaning the patient confirms the input information multiple times. As another example, when a user engages in human-computer dialogue through an artificial intelligence platform, the platform also receives the input information determined by user and uses the large language model to reason through the input information to obtain the corresponding output information, which is then displayed to the user.

The output information includes multiple tokens, and each token is displayed sequentially according to the order obtained through reasoning.

In some embodiments, after a dialogue is triggered, for each round of dialogue, the input prompt information of a current dialogue is obtained. The dialogue may include multiple rounds. For example, the user selects question A as input to the model, the model outputs answer A for question A and displays answer A on the screen, and after answer A is received, the user selects question B as input to the model, and the model outputs answer B for question B and displays answer B on the screen. If the user does not enter any more questions or confirms the end of the dialogue (e.g., exiting the application or terminal corresponding to the model), then this dialogue includes two rounds. This is just one example.

In the case of a dialogue including multiple rounds, the current dialogue can be any one of those multiple rounds. Furthermore, the input prompt information can include all input tokens determined by the user, a portion of tokens determined by the user, and tokens inferred by the model during its inference process based on the input prompt information.

At S102, based on model inference, first token output information and predicted token output information corresponding to the input prompt information are generated.

After the input prompt information of the current dialogue is obtained, model inference is performed using the model to generate the first token output information and the predicted token output information corresponding to the input prompt information. The first token output information includes the tokens corresponding to the input prompt information, and the predicted token output information is generated by the model during the inference stage based on reference token pairs. For example, the input prompt information includes “Alan Turing,” the first token output information generated after model inference by the model includes “is,” and the predicted token output information includes “a who great the he just a….”

The reference token pairs used to generate the predicted token output information corresponding to the input prompt information are related to the attributes of the current dialogue. For example, after the input prompt information of the current dialogue is obtained, the attributes of the current dialogue can be obtained first, and reference token pairs can be determined based on these attributes of the current dialogue to generate the predicted token output information.

In some embodiments, obtaining the attributes of the current dialogue may include: determining the application scenario to which the current dialogue belongs, the user profile corresponding to the current dialogue, and the identity information of the user corresponding to the current dialogue based on the model. After the attributes of the current dialogue are obtained, reference token pairs are determined based on the application scenario, user profile, and identity information, and the predicted token output information is generated based on the determined reference token pairs.

For example, the application scenario of the current dialogue can be determined by identifying the content of the current dialogue using the model. For instance, if the dialogue is identified to include phrases like “runny nose” and “fever,” the scenario of the current dialogue is determined to be medical scenario; if the dialogue is identified to include phrases like “weather,” “temperature,” and a specific address, the scenario of the current dialogue is determined to be a travel planning scenario.

As another example, the application scenario of the current dialogue can be determined based on the model’s recognition of the content of the current dialogue, the application scenario of the current dialogue can also be determined by combining the electronic device information and user information corresponding to the current dialogue, so as to ensure that the determined application scenario is accurate. For instance, if the content of the current dialogue is identified to include phrases like “runny nose” and “fever,” the electronic device information corresponding to the current dialogue is determined to include the electronic device being a mobile phone according to the positioning apparatus, and the user information corresponding to the current dialogue is determined to include the user having a history of online medical consultations based on model-related applications. Based on the above findings, application scenario of the current dialogue is determined to be an online medical consultation.

As another example, user profiles corresponding to electronic devices and identity information corresponding to application accounts can be pre-built. Therefore, after the electronic device corresponding to the current dialogue is determined, the user profile corresponding to the current dialogue can be obtained, and after the application corresponding to the current dialogue is determined, the user’s identity information corresponding to the current dialogue can be obtained.

The present disclosure does not limit the method of obtaining the application scenario to which the current dialogue belongs, the electronic device information corresponding to the current dialogue, and the user information corresponding to the current dialogue, as long as they can be obtained.

After the first token output information and the predicted token output information corresponding to the input prompt information are obtained, the output information corresponding to the input prompt information can be obtained and displayed to the user to realize the dialogue with the user.

In the model inference method of the present disclosure, during the inference stage based on the input prompt information of the current dialogue, the model not only generates the first token output information corresponding to the input prompt information, but also generates predicted token output information based on reference token pairs, further, the predicted token output information includes multiple predicted token pairs, thereby enabling the simultaneous generation of multiple output tokens corresponding to the input prompt information based on the predicted token output information. Furthermore, the reference token pairs are related to the attributes of the current dialogue, thus enabling accurate and rapid acquisition of the output information corresponding to the input prompt information, greatly improving the user experience.

In some embodiments, during the inference stage, the predicted token output information can be generated based on reference token pairs in any one of the following two methods.

First method is described below.

In response to obtaining initial prompt information input by the user in the current dialogue, the reference token pair information library is called through the model. The initial prompt information includes the first prompt information received after the user triggers the dialogue or the model starts the inference process. This reference token pair information library is stored in the electronic device corresponding to the current dialogue, and the reference token pair information library includes multiple reference token pairs, each reference token pair including two tokens with a certain sequential relationship. For example, reference token pairs include who-is, great-intent, the-best, he-is, just-a, etc.

In embodiments of the disclosure, the reference token pair information library is stored in the electronic device corresponding to the current dialogue, so that the reference token pair information library can be invoked when dialogue is initiated or the model inference is started, effectively improving model inference efficiency compared to building the reference token pair information library during the model inference process.

After the reference token pair information library is invoked, based on the first reference token pair in the reference token pair information library, the predicted token output information corresponding to the input information is generated. The first reference token pair is a reference token pair in the reference token pair information library related to the attributes of the current dialogue.

For example, when determining the first reference token pair, reference can be made to the above method for determining the application scenario to which the current dialogue belongs to determine the target scenario related to the attributes of the current dialogue. The specific determination process is not elaborated here.

After the target scenario related to the attributes of the current dialogue is determined, the reference token pairs in the reference token pair information library corresponding to the target scenario is further determined. Each reference token pair in the reference token pair information library can be applied to one or more application scenarios. Furthermore, each reference token pair has a correlation with the application scenarios to which the reference token pair can be applied. After the target scenario related to the attributes of the current dialogue is determined, the reference token pair corresponding to the target scenario can be searched from the reference token pair information library based on the correlation between the reference token pair and the application scenario.

As another example, all reference token pairs in the reference token pair information library can be divided into multiple reference token pair sub information-libraries according to application scenarios. Each reference token pair sub information-library contains reference token pairs corresponding to the same application scenario. Then, after the reference token pair corresponding to the target scenario is determined, the reference token pair sub information-library corresponding to the target scenario, that is, the reference token pair sub information-library to which the reference token pair corresponding to the target scenario belongs is called. The reference token pair included in this reference token pair sub information-library is the first reference token pair.

The second method involves responding to the initial prompt information input by the user in the current dialogue is obtained and creating a token pair buffer pool. Similarly, the initial prompt information is the first prompt information received after the user triggers the dialogue or the model starts the inference process. The token pair buffer can be created on the electronic device corresponding to the current dialogue, or the token pair buffer can be created internally within the model as model parameters, etc.

The token pair buffer is constructed after the model starts the inference process. The token pair buffer buffers the current token pairs generated during inference of the current dialogue. That is, multiple current token pairs are generated during inference, and the multiple current token pairs are buffered in the token pair buffer pool. In other words, as the number of model inferences increases, the number of current token pairs in the token pair buffer pool gradually increases, meaning the token pair buffer pool includes at least one current token pair.

After the token pair buffer is crested in response to the initial prompt information, the token pair buffer is loaded based on the reference token pair information library. Specifically, the token pair buffer pool is loaded based on a second reference token pair in the reference token pair information library. The second reference token pair in the reference token pair information library is a reference token pair in the reference token pair information library related to the attributes of the current dialogue. For example, when loading the token pair buffer pool based on the reference token pair information library, a target scenario related to the attributes of the current dialogue is determined. The reference token pair corresponding to the target scenario in the reference token pair information library is then identified, and the reference token pair corresponding to the target scenario is loaded into the token pair buffer pool. The reference token pair loaded into the token pair buffer pool is the second reference token pair.

The specific method for determining the target scenario and the corresponding reference token pair is described above and will not be elaborated further here.

It is worth noting that the action of loading the token pair buffer pool based on the reference token pair information library can be performed before the current token pairs are buffered in the token pair buffer pool, or during the process of buffering the current token pairs in the token pair buffer pool. The present disclosure does not limit this.

After the token pair buffer pool buffers the current token pairs and the token pair buffer pool is loaded based on the reference token pair information library, the token pair buffer pool will contain both the second reference token pair and the current token pair. Then, through model inference, based on the second reference token pair in the token pair buffer pool and the current token pair, the predicted token output information corresponding to the input prompt information is generated.

For example, FIG. 2 is a flowchart of updating the reference token pair information library, which includes S201-S203.

At S201, the predicted token output information is decoded to obtain predicted token pair information.

At S202, the target token pairs in the predicted token pair information that are related to the target scenario are determined.

At S203, the reference token pair information library is updated based on the target token pairs.

After the predicted token output information corresponding to the input prompt information is generated based on model inference, the predicted token output information is decoded to obtain the predicted token pair information. After the predicted token output information is decoded, the number of predicted token pairs, the frequency information of the predicted token pairs, and the application scenario corresponding to the predicted token pairs can also be obtained.

After the predicted token pair information is obtained, based on the correlation between the reference token pair (the predicted token pairs are potion of the reference token pairs) and the application scenario, target token pairs in the predicted token pair information that are related to the target scenario are determined. In some embodiments, after the verification predicted token pair information is obtained based on model inference, model inference is further performed to verify whether there are related token pairs in the predicted token pair information that are associated with the first token output information. The relationship between the related token pair and the first token corresponding to the first token output information is a contextual relationship, and the contextual relationship between the related token pair and the first token indicates that the related token pair is related to the target scenario.

In other words, model inference is performed on the first token based on the model to determine the next token of the first token, or model inference is performed on the first token and the corresponding text paragraph based on the model to determine the next token of the first token. After the next token of the first token is determined, whether the next token is in the predicted token pair information is determined, and this next token is in the first position of the predicted token pair. The two tokens in the predicted token pair also have a sequential order. The token that comes first in the sequence is in the first position, and the token that that comes later in the sequence is in the second position.

If there is a related token pair in the predicted token pair information that is associated with the first token output information, then a target token pair is determined based on the related token pair, and the reference token pair information library is updated based on the target token pairs.

There are one or more target token pairs. For example, if there is one related token pair, there is also one target token pair. If there are multiple related token pairs, some related token pairs can be randomly selected from all related token pairs to be the target token pairs, or some related token pairs can be selected according to certain selection rules to be the target token pairs, etc. The selection rules may include, for example, selecting the first three related token pairs in the order the related token pairs were generated to be the target token pairs.

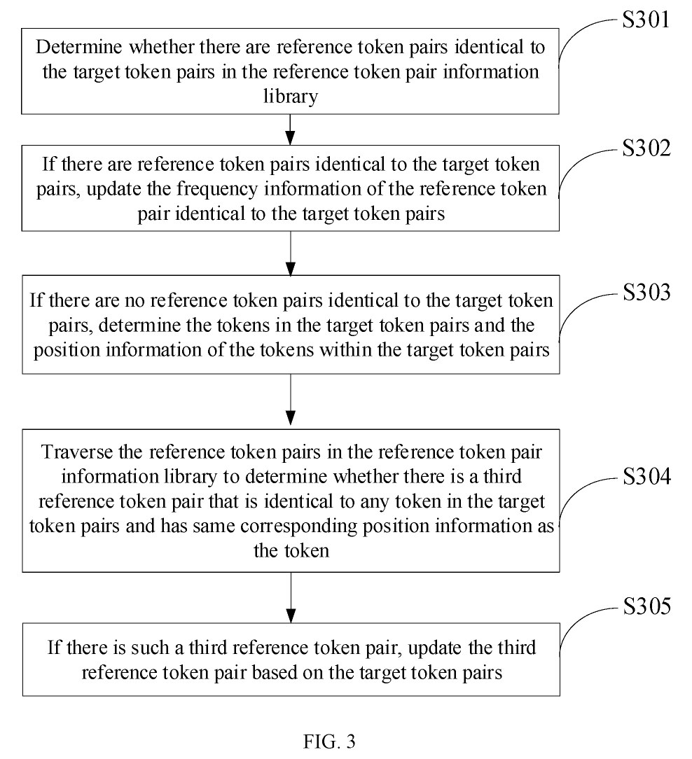

When the target token pairs are determined, reference can be made to the flowchart shown in FIG. 3 for updating the reference token pair information library based on the target token pairs. The process in FIG. 3 includes S301-S305.

At S301, whether there are reference token pairs identical to the target token pairs in the reference token pair information library is determined.

At S302, if there are reference token pairs identical to the target token pairs, the frequency information of the reference token pair identical to the target token pairs is updated.

At S303, if there are no reference token pairs identical to the target token pairs, the tokens in the target token pairs and the position information of the tokens within the target token pairs are determined.

At S304, the reference token pairs in the reference token pair information library are traversed to determine whether there is a third reference token pair that is identical to any token in the target token pairs and has same corresponding position information as the token.

At S305, if there is a third reference token pair that is identical to a token in the target token pairs and has same corresponding position information as the token, the third reference token pair is updated based on the target token pairs.

During the model inference process of the current dialogue, predicted token pair information is continuously generated, i.e., target token pairs are continuously generated. Then, the reference token pair information library can be updated based on the target token pairs during the model inference process of the current dialogue. The reference token pair information library can also be updated based on the target token pairs after the current dialogue ends. The present disclosure does not limit the update timing of the reference token pair information library.

The reference token pair information library includes multiple reference token pairs. When updating the reference token pair information library based on the target token pairs, whether there are reference token pairs in the reference token pair information library that are identical to the target token pairs is determined.

If there are reference token pairs identical to the target token pairs, the frequency information of the reference token pair identical to the target token pairs is updated. Each reference token pair is configured with a corresponding frequency information, the corresponding frequency information represents the number of times the reference token pair is inferred by the model within the target time period and the number of times the reference token pair appears in the dialogue.

If there are no reference token pairs identical to the target token pairs, for each target token pairs, the tokens in the target token pairs and the position information of the tokens in the target token pairs are determined. For example, if the target token pair is “who-is”, the tokens in the target token pairs includes “who” and “is”, and the position information of “who” in the target token pairs is the first position of the target token pairs, while the position information of “is” in the target token pairs is the second position of the target token pairs.

After the tokens in the target token pairs and the position information of the tokens in the target token pairs are determined, reference token pairs in the reference token pair information library are traversed to determine if there is a third reference token pair identical to any token in the target token pairs and the corresponding position information of the tokens in the target token pairs. If there is a third reference token pair, update the third reference token pair based on the target token pairs.

In some embodiments, when updating the third reference token pair based on the target token pairs, the number of third reference token pairs is determined. If there is only one third reference token pair, update the third reference token pair based on the target token pairs, that is , replace the third reference token pair the target token pairs.

If there are multiple third reference token pairs, the frequency information for each reference token pair is determined. This frequency information represents the number of times the third reference token pair is inferred by the model within a target time period and the number of times the reference token pair appears in the dialogue. The target time period can be determined based on the frequency of model inference. Then, the third reference token pair with the lowest frequency in the frequency information is updated based on the target token pairs.

Through the above processes for updating the reference token pair information library, the reference token pairs in the information base can be ensured to be accurate and meet the user’s needs at the current stage.

The present disclosure also provides an electronic device. Since the principle by which the electronic device solves the problem in the present disclosure is similar to the model inference method described above, the implementation of the electronic device can be found in the implementation of the method, and repeated details will not be elaborated further.

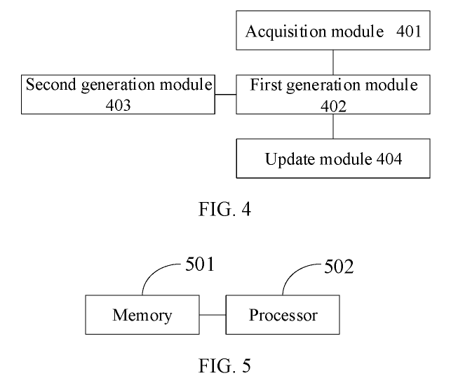

FIG. 4 is a schematic structural diagram of an electronic device consistent with the present disclosure, specifically including an acquisition module 401, configured to acquire input prompt information of the current dialogue, and a first generation module 402, configured to generate first token output information and predicted token output information corresponding to the input prompt information based on model inference.

During inference, the predicted token output information is generated based on reference token pairs, and the reference token pairs are related to the attributes of the current dialogue.

In some embodiments, the electronic device further includes a second generation module 403, configured to respond to receiving initial prompt information input by the user in the current dialogue, invoke a reference token pair information library through the model, generate predicted token output information corresponding to the input information based on a first reference token pair in the reference token pair information library.

In some embodiments, the second generation module 403 can be further configured to respond to receiving initial prompt information input by the user in the current dialogue, create a token pair buffer pool buffering current token pairs generated during inference of the current dialogue, load the token pair buffer pool based on the reference token pair information library, generate predicted token output information corresponding to the input prompt information through model inference, based on a second reference token pair in the token pair buffer pool and the current token pairs.

In some embodiments, the second generation module 403 is further configured to determine a target scenario related to the attributes of the current dialogue, determine reference token pairs in the reference token pair information library corresponding to the target scenario, call the reference token pair sub information-library corresponding to the target scenario in the reference token pair information library, or load the reference token pairs corresponding to the target scenario into the token pair buffer pool.

In some embodiments, the electronic device further includes an update module 404, configured to decode the predicted token output information to obtain predicted token pair information, determine the target token pairs related to the target scenario from the predicted token pair information, and update the reference token pair information library based on the target token pairs.

In some embodiments, the update module 404 is further configured to, based on the model inference, verify whether there is a related token pair in the predicted token pair information that is associated with the first token output information. The related token pair and the first token corresponding to the first token output information have a contextual relationship. If there is a related token pair in the predicted token pair information that is associated with the first token output information, determine the target token pairs based on the related token pair. There are one or more target token pairs.

In some embodiments, the update module 404 is further configured to, determine whether there are reference token pairs in the reference token pair information library that are identical to the target token pairs, if not, determine the tokens in the target token pairs and the position information of the tokens in the target token pairs, traverse the reference token pairs in the reference token pair information library to determine whether there is a third reference token pair that is identical to any token in the target token pairs and the corresponding position information of the tokens, if there is a related token pair in the predicted token pair information that is associated with the first token output information, update the third reference token pair based on the target token pairs.

In some embodiments, the update module 404 is further configured to, if there is only one third reference token pair, update the third reference token pair based on the target token pairs, if there are multiple third reference token pairs, determine the frequency information corresponding to each third reference token pair, the frequency information representing the number of times the third reference token pair is inferred by the model within the target time period and the number of times the reference token pair appears in the dialogue, and update the third reference token pair with the smallest frequency in the frequency information based on the target token pairs.

In some embodiments, the update module 404 is further configured to, determine whether there are reference token pairs in the reference token pair information library that are identical to the target token pairs, if so, update the frequency information of the reference token pair that are identical to the target token pairs.

In the model inference method of the present disclosure embodiment, during inference based on the input prompt information of the current dialogue, the model not only generates first token output information corresponding to the input prompt information, but also generates predicted token output information based on reference token pairs, the predicted token output information including multiple predicted token pairs, thereby enabling the simultaneous generation of multiple output tokens corresponding to the input prompt information based on the predicted token output information. Furthermore, the reference token pairs are related to the attributes of the current dialogue, thus enabling accurate and rapid acquisition of the output information corresponding to the input prompt information, greatly improving the user experience.

The present disclosure also provides another electronic device, the schematic structural diagram is shown in FIG. 5. The electronic device includes at least a memory 501 and a processor 502. The memory 501 stores an executable program, and the processor 502 implements the model inference method provided in any embodiment of the present disclosure when executing the executable program on the memory 501. For example, the processes of the electronic device computer program include S11 and S12.

At S11, input prompt information of a current dialogue is obtained.

At S12, based on model inference, first token output information and predicted token output information corresponding to the input prompt information are generated.

During inference, the predicted token output information is generated based on reference token pairs, and the reference token pairs are related to the attributes of the current dialogue.

The present disclosure provides a computer program product, which includes a computer program/instruction. When executed by a processor, the computer program/instruction implements the model inference method provided in any embodiment of the present disclosure. The computer program/instruction includes the following processes.

At S21, input prompt information of a current dialogue is obtained.

At S22, based on model inference, first token output information and predicted token output information corresponding to the input prompt information are generated.

During inference, the predicted token output information is generated based on reference token pairs, and the reference token pairs are related to the attributes of the current dialogue.

In the model inference method of the present disclosure embodiment, during inference based on the input prompt information of the current dialogue, the model not only generates first token output information corresponding to the input prompt information, but also generates predicted token output information based on reference token pairs, further, the predicted token output information includes multiple predicted token pairs, thereby enabling the simultaneous generation of multiple output tokens corresponding to the input prompt information. Furthermore, the reference token pairs are related to the attributes of the current dialogue, thus enabling accurate and rapid acquisition of the output information corresponding to the input prompt information, greatly improving the user experience.

It should be understood that in the present disclosure embodiment, the processor can be a Central Processing Unit (CPU), a general-purpose processor, a digital signal processor (DSP), an application-specific integrated circuits (ASICs), a field-programmable gate array (FPGA), or other programmable logic device, discrete gate or transistor logic device, discrete hardware component, etc.

It should also be understood that the memory mentioned in the embodiments of the present disclosure can be volatile memory or non-volatile memory, or may include both volatile and non-volatile memory. Non-volatile memory can be read-only memory (ROM), programmable read-only memory (PROM), erasable programmable read-only memory (EPROM), electrically erasable programmable read-only memory (EEPROM), or flash memory. Volatile memory can be random access memory (RAM), which is used as an external cache. By way of example, but not limitation, many forms of RAM are available, such as Static Random Access Memory (SRAM), Dynamic Random Access Memory (DRAM), Synchronous DRAM (SDRAM), Double Data Rate SDRAM (DDR SDRAM), Enhanced Synchronous DRAM (ESDRAM), Synchronous Link DRAM (SLDRAM), and Direct Rambus RAM (DR RAM).

It should be noted that when the processor is a general-purpose processor, DSP, ASIC, FPGA, or other programmable logic device, discrete gate or transistor logic device, or discrete hardware component, the memory (storage module) is integrated into the processor.

It should be noted that the memory described herein is intended to include, but is not limited to, these and any other suitable types of memory.

A bus in the electronic device may include, in addition to a data bus, a power bus, a control bus, and a status signal bus, etc. However, for clarity, all buses are labeled as buses in the figures. It should also be understood that the terms associated with “first,” “second,” “third,” “fourth,” and various numerical designations used herein are merely for descriptive convenience and are not intended to limit the scope of the present disclosure.

It should be understood that the term “and/or” in this document is simply a description of the relationship between related objects, indicating that there are three relationships. For example, A and/or B can include: A alone, A and B, and B alone. Furthermore, the character “/” in this document generally indicates that the preceding and following related objects have an “or” relationship.

In implementation, the processes of the above method can be completed by integrated logic circuits in the processor’s hardware or by instructions in software form. The processes of the method disclosed in the embodiments of the present disclosure can be directly embodied in the execution of the hardware processor, or by a combination of hardware and software modules in the processor. The software modules can reside in random access memory, flash memory, read-only memory, programmable read-only memory, electrically erasable programmable memory, registers, or other storage media in the art. This storage medium is located in memory, and the processor reads the information in the memory and, in conjunction with the hardware, completes the processes of the above method.

In the various embodiments of the present disclosure, the sequence numbers of the above processes do not imply a sequential order of execution. The execution order of each process should be determined by function and internal logic, and should not constitute any limitation on the implementation process of the embodiments of the present disclosure.

Those skilled in the art will recognize that the various illustrative logical blocks (ILBs) and processes described in conjunction with the embodiments disclosed herein can be implemented in electronic hardware, or a combination of computer software and electronic hardware. Whether these functions are implemented in hardware or software depends on the specific application and design constraints of the technical solution. Those skilled in the art can use different methods to implement the described functions for each specific application, but such implementation should not be considered beyond the scope of the present disclosure.

What is claimed is:

1. A model inference method comprising:
obtaining input prompt information of a current dialogue; and
generating first token output information and predicted token output information corresponding to the input prompt information based on model inference, the predicted token output information being generated based on reference token pairs related to attributes of the current dialogue.

2. The method according to claim 1, wherein the predicted token output information is generated by:
in response to obtaining initial prompt information input by a user in the current dialogue, calling a reference token pair information library through a model used in the model inference; and
generating the predicted token output information corresponding to the initial prompt information based on a first reference token pair in the reference token pair information library.

3. The method according to claim 2, further comprising:
determining a target scenario related to the attributes of the current dialogue;
determining the reference token pairs in the reference token pair information library that correspond to the target scenario; and
calling a reference token pair sub information-library corresponding to the target scenario in the reference token pair information library.

4. The method according to claim 1, wherein the predicted token output information is generated by:
in response to obtaining initial prompt information input by a user in the current dialogue, creating a token pair buffer pool buffering one or more current token pairs generated in the current dialogue during inference;
loading the token pair buffer pool based on a reference token pair information library; and
generating, through the model inference, the predicted token output information corresponding to the input prompt information based on a second reference token pair in the token pair buffer pool and the one or more current token pairs.

5. The method according to claim 4, further comprising:
determining a target scenario related to the attributes of the current dialogue;
determining the reference token pairs in the reference token pair information library that correspond to the target scenario; and
loading the reference token pairs corresponding to the target scenario into the token pair buffer pool.

6. The method according to claim 1, further comprising:
decoding the predicted token output information to obtain predicted token pair information;
determining one or more target token pairs in the predicted token pair information that are related to a target scenario related to the attributes of the current dialogue; and
updating a reference token pair information library based on the one or more target token pairs.

7. The method according to claim 6, wherein determining the one or more target token pairs includes:
based on the model inference, verifying whether a related token pair exists in the predicted token pair information, is the related token pair being associated with the first token output information and having a contextual relationship with a first token corresponding to the first token output information; and
in response to the related token pair existing in the predicted token pair information, determining the one or more target token pairs based on the related token pair.

8. The method according to claim 6, wherein updating the reference token pair information library includes:
determining whether the reference token pair information library includes one or more reference token pairs that are identical to the one or more target token pairs; and
in response to determining that the reference token pair information library does not include one or more reference token pairs that are identical to the target token pairs:
determining tokens in the target token pairs and position information of the tokens in the target token pairs;
traversing reference token pairs in the reference token pair information library, to determine whether the reference token pair information library includes one or more third reference token pairs each being identical to one token in the target token pairs and having same position information as the one token; and
in response to determining that the reference token pair information library includes the one or more third reference token pairs:
updating the one or more third reference token pair based on the one or more target token pairs.

9. The method according to claim 7, wherein updating the one or more third reference token pairs includes:
in response to there being only one third reference token pair, updating the third reference token pair based on the one or more target token pairs; and
in response to the one or more third reference token pairs include a plurality of third reference token pairs:
determining a plurality of pieces of frequency information each corresponding to one third reference token pair of the plurality of third reference token pairs and representing a number of times the one third reference token pair is obtained by the model inference within a target time period and a number of times the one third reference token pair appears in the current dialogue; and
updating, based on the one or more target token pairs, one of the one or more third reference token pairs corresponding to the frequency information with a smallest frequency.

10. The method according to claim 6, wherein updating the reference token pair information library includes:
determining whether the reference token pair information library includes one reference token pair identical to one of the one or more target token pairs; and
in response to the reference token pair information library including the one reference token pair identical to the one of the one or more target token pairs, updating frequency information of the one reference token pair.

11. An electronic device comprising:
a processor, and
a memory storing an application program that, when executed by the processor, causes the electronic device to:
obtain input prompt information of a current dialogue; and
generate first token output information and predicted token output information corresponding to the input prompt information based on model inference, the predicted token output information being generated based on reference token pairs related to attributes of the current dialogue.

12. The electronic device according to claim 11, wherein the predicted token output information is generated by:
in response to obtaining initial prompt information input by a user in the current dialogue, calling a reference token pair information library through a model used in the model inference; and
generating the predicted token output information corresponding to the initial prompt information based on a first reference token pair in the reference token pair information library.

13. The electronic device according to claim 12, wherein the application program, when executed by the processor, further causes the electronic device to:
determine a target scenario related to the attributes of the current dialogue;
determine the reference token pairs in the reference token pair information library that correspond to the target scenario; and
call a reference token pair sub information-library corresponding to the target scenario in the reference token pair information library.

14. The electronic device according to claim 11, wherein the predicted token output information is generated by:
in response to obtaining initial prompt information input by a user in the current dialogue, creating a token pair buffer pool buffering one or more current token pairs generated in the current dialogue during inference;
loading the token pair buffer pool based on a reference token pair information library; and
generating, through the model inference, the predicted token output information corresponding to the input prompt information based on a second reference token pair in the token pair buffer pool and the one or more current token pairs.

15. The electronic device according to claim 14, wherein the application program, when executed by the processor, further causes the electronic device to:
determine a target scenario related to the attributes of the current dialogue;
determine the reference token pairs in the reference token pair information library that correspond to the target scenario; and
load the reference token pairs corresponding to the target scenario into the token pair buffer pool.

16. The electronic device according to claim 11, wherein the application program, when executed by the processor, further causes the electronic device to:
decode the predicted token output information to obtain predicted token pair information;
determine one or more target token pairs in the predicted token pair information that are related to a target scenario related to the attributes of the current dialogue; and
update a reference token pair information library based on the one or more target token pairs.

17. The electronic device according to claim 16, wherein the application program, when executed by the processor, further causes the electronic device to, when determining the one or more target token pairs:
based on the model inference, verify whether a related token pair exists in the predicted token pair information, is the related token pair being associated with the first token output information and having a contextual relationship with a first token corresponding to the first token output information; and
in response to the related token pair existing in the predicted token pair information, determine the one or more target token pairs based on the related token pair.

18. The electronic device according to claim 16, wherein the application program, when executed by the processor, further causes the electronic device to, when updating the reference token pair information library:
determine whether the reference token pair information library includes one or more reference token pairs that are identical to the one or more target token pairs; and
in response to determining that the reference token pair information library does not include one or more reference token pairs that are identical to the target token pairs:
determine tokens in the target token pairs and position information of the tokens in the target token pairs;
traverse reference token pairs in the reference token pair information library, to determine whether the reference token pair information library includes one or more third reference token pairs each being identical to one token in the target token pairs and having same position information as the one token; and
in response to determining that the reference token pair information library includes the one or more third reference token pairs:
update the one or more third reference token pair based on the one or more target token pairs.

19. The electronic device according to claim 17, wherein the application program, when executed by the processor, further causes the electronic device to, when updating the one or more third reference token pairs:
in response to there being only one third reference token pair, update the third reference token pair based on the one or more target token pairs; and
in response to the one or more third reference token pairs include a plurality of third reference token pairs:
determine a plurality of pieces of frequency information each corresponding to one third reference token pair of the plurality of third reference token pairs and representing a number of times the one third reference token pair is obtained by the model inference within a target time period and a number of times the one third reference token pair appears in the current dialogue; and
update, based on the one or more target token pairs, one of the one or more third reference token pairs corresponding to the frequency information with a smallest frequency.

20. A non-transitory computer-readable storage medium storing an application program that, when executed by a processor, causes an electronic device including the processor to:
obtain input prompt information of a current dialogue; and
generate first token output information and predicted token output information corresponding to the input prompt information based on model inference, the predicted token output information being generated based on reference token pairs related to attributes of the current dialogue.
